(19) United States
(12) Patent Application Publication
(10) Pub. No.: US 2025/0278820 A1
(43) Pub. Date: Sep. 4, 2025

(54) TOWARDS UNSUPERVISED BLIND FACE RESTORATION USING DIFFUSION MODELS

(71) Applicant: SAMSUNG ELECTRONICS CO., LTD., Suwon-si (KR)

(72) Inventors: Tianshu KUAI, Montreal (CA); Sina HONARI, Toronto (CA); Aleksai LEVINSHTEIN, Thornhill (CA); Igor GILITSCHENSKI, Toronto (CA)

(73) Assignee: SAMSUNG ELECTRONICS CO., LTD., Suwon-si (KR)

(21) Appl. No.: 19/066,959

(22) Filed: Feb. 28, 2025

Related U.S. Application Data
(60) Provisional application No. 63/560,164, filed on Mar. 1, 2024.

(51) Int. Cl. G06T 5/60; G06T 5/70

(52) U.S. Cl. CPC G06T 5/60; G06T 5/70; G06T 2207/20081

(57) ABSTRACT

Methods, systems, and apparatuses for training an image restoration model, including: performing pre-training on the image restoration model based on a synthetic training dataset to obtain a pre-trained image restoration model; providing a plurality of real degraded images as input to the pre-trained image restoration model to obtain a plurality of initial restored images; generating a plurality of pseudo-target images by providing the plurality of initial restored images as input to a denoising diffusion model; calculating a training loss corresponding to the plurality of initial restored images and the plurality of pseudo-target images; and modifying at least one parameter of the pre-trained image restoration model based on the training loss to obtain a trained image restoration model.

### CROSS-REFERENCE TO RELATED APPLICATION(S)

This application is based on and claims priority under 35 U.S.C. § 119 to U.S. Provisional Patent Application No. 63/560,164, filed on Mar. 1, 2024, in the U.S. Patent & Trademark Office, the disclosure of which is incorporated by reference herein in its entirety.

### BACKGROUND

### 1. Field

The disclosure relates to image restoration, and more particularly to unsupervised training of a blind image restoration model using image diffusion.

### 2. Description of Related Art

Image restoration is an important task in computational photography that aims to recover a high-quality image from a low-quality counterpart, which may be for example a degraded image that exhibits degradations such as blurring, noise, compression artifacts, etc. Blind image restoration, in which the degradation process is unknown, may be a more challenging task. Blind image restoration techniques may involve a balance between maintaining the fidelity of the image content and the maintaining a perceptual quality of the restored image. This balance may be particularly important in fields such as blind face restoration, because both fidelity and quality may be important when restoring images of faces.

Some approaches to blind image restoration use image restoration models which are trained in a supervised manner, for example using paired training datasets which includes training pairs of low-quality input images and corresponding high-quality target images. The training pairs may be constructed by manually designing a degradation process in which a high-quality image may be synthetically degraded to form the corresponding low-quality input image. Image restoration models produced using this supervised learning may achieve acceptable performance on input images that align with the particular degradations included in the paired training dataset. However, these image restoration models may produce severe artifacts when tested on input images that do not align with the degradations used in training. In addition, it may be difficult to find a sufficiently large paired training dataset to perform the supervised learning.

Other approaches to blind image restoration may use image diffusion models. Due to their powerful and robust modeling of the natural image manifold, pre-trained diffusion models may be used as priors for image restoration tasks in a zero-shot manner. However, these approaches may require sampling process during inference, which results in a significant computational cost and extremely slow runtime.

Therefore, there is a need for techniques which may be used to perform unsupervised training of a blind image restoration model, for example using degraded images without access to ground-truth target images, and without knowledge of the particular degradations exhibited by the degraded images, in which the image restoration model is less complex than an image diffusion model.

### SUMMARY

Example embodiments address at least the above problems and/or disadvantages and other disadvantages not described above. Also, the example embodiments are not required to overcome the disadvantages described above, and may not overcome any of the problems described above.

In accordance with an aspect of the disclosure, a method of training an image restoration model includes: performing pre-training on the image restoration model based on a synthetic training dataset to obtain a pre-trained image restoration model; providing a plurality of real degraded images as input to the pre-trained image restoration model to obtain a plurality of initial restored images; generating a plurality of pseudo-target images by providing the plurality of initial restored images as input to a denoising diffusion model; calculating a training loss corresponding to the plurality of initial restored images and the plurality of pseudo-target images; and modifying at least one parameter of the pre-trained image restoration model based on the training loss to obtain a trained image restoration model.

The method may further include: restoring a real degraded image by providing the real degraded image as input to the trained image restoration model to obtain a restored image.

The synthetic training dataset may be obtained by obtaining a plurality of real images, and applying synthetic degradation to the plurality of real images to obtain a plurality of synthetic degraded images.

The generating of the plurality of pseudo-target images may include applying a forward diffusion process and a reverse denoising process to the plurality of initial restored images.

The forward diffusion process may include a plurality of forward diffusion steps, and the reverse denoising process may include a plurality of reverse diffusion steps.

The reverse denoising process may include applying a constraint on a predetermined number of steps from among the plurality of reverse diffusion steps.

The applying the constraint may include performing denoising on a high-frequency component of an intermediate image corresponding to a reverse diffusion step from among the plurality of reverse diffusion steps, without performing the denoising on a low-frequency component of the intermediate image.

Remaining steps from among the plurality of reverse diffusion steps may be unconstrained.

In accordance with an aspect of the disclosure, an electronic device for training an image restoration model includes: at least one memory configured to store instructions; and at least one processor configured to execute the instructions to: perform pre-training on the image restoration model based on a synthetic training dataset to obtain a pre-trained image restoration model; provide a plurality of real degraded images as input to the pre-trained image restoration model to obtain a plurality of initial restored images; generate a plurality of pseudo-target images by providing the plurality of initial restored images as input to a denoising diffusion model; calculate a training loss corresponding to the plurality of initial restored images and the plurality of pseudo-target images; and modify at least one parameter of the pre-trained image restoration model based on the training loss to obtain a trained image restoration model.

The at least one processor may be further configured to: restore a real degraded image by providing the real degraded image as input to the trained image restoration model to obtain a restored image.

The synthetic training dataset may be obtained by obtaining a plurality of real images, and applying synthetic degradation to the plurality of real images to obtain a plurality of synthetic degraded images.

To generate the plurality of pseudo-target images, the at least one processor may be further configured to apply a forward diffusion process and a reverse denoising process to the plurality of initial restored images.

The forward diffusion process may include a plurality of forward diffusion steps, and the reverse denoising process may include a plurality of reverse diffusion steps.

The reverse denoising process may include applying a constraint on a predetermined number of steps from among the plurality of reverse diffusion steps.

To apply the constraint, the at least one processor may be further configured to perform denoising on a high-frequency component of an intermediate image corresponding to a reverse diffusion step from among the plurality of reverse diffusion steps, without performing the denoising on a low-frequency component of the intermediate image.

Remaining steps from among the plurality of reverse diffusion steps are unconstrained.

In accordance with an aspect of the disclosure, a non-transitory computer-readable medium stores instructions which, when executed by at least one processor of a device for training an image restoration model, cause the device to: perform pre-training on the image restoration model based on a synthetic training dataset to obtain a pre-trained image restoration model; provide a plurality of real degraded images as input to the pre-trained image restoration model to obtain a plurality of initial restored images; generate a plurality of pseudo-target images by providing the plurality of initial restored images as input to a denoising diffusion model; calculate a training loss corresponding to the plurality of initial restored images and the plurality of pseudo-target images; and modify at least one parameter of the pre-trained image restoration model based on the training loss to obtain a trained image restoration model.

The instructions may further cause the at least one processor to: restore a real degraded image by providing the real degraded image as input to the trained image restoration model to obtain a restored image.

The synthetic training dataset may be obtained by obtaining a plurality of real images, and applying synthetic degradation to the plurality of real images to obtain a plurality of synthetic degraded images.

To generate the plurality of pseudo-target images, the instructions may further cause the at least one processor to apply a forward diffusion process and a reverse denoising process to the plurality of initial restored images.

### BRIEF DESCRIPTION OF THE DRAWINGS

The above and other aspects, features, and aspects of embodiments of the disclosure will be more apparent from the following description taken in conjunction with the accompanying drawings, in which:

FIG. 1 is a diagram showing a general overview of an electronic device including an image restoration model, according to embodiments;

FIG. 2 is a flowchart of a process for training an image restoration model, according to embodiments;

FIG. 3 is a diagram illustrating a denoising diffusion process, according to embodiments;

FIG. 4 is a diagram illustrating a result of a low-frequency content constrained denoising diffusion process, according to embodiments;

FIG. 5 is a flowchart of a process for generating pseudo-target images, according to embodiments;

FIG. 6 is a diagram for explaining a fine-tuning procedure for an image restoration model, according to embodiments;

FIG. 7 is a flowchart of a process for training an image restoration model, according to embodiments; and

FIG. 8 is a block diagram of an electronic device according to embodiments.

### DETAILED DESCRIPTION

Example embodiments are described in greater detail below with reference to the accompanying drawings.

In the following description, like drawing reference numerals are used for like elements, even in different drawings. The matters defined in the description, such as detailed construction and elements, are provided to assist in a comprehensive understanding of the example embodiments. However, it is apparent that the example embodiments can be practiced without those specifically defined matters. Also, well-known functions or constructions are not described in detail since they would obscure the description with unnecessary detail.

Expressions such as “at least one of,” when preceding a list of elements, modify the entire list of elements and do not modify the individual elements of the list. For example, the expression, “at least one of a, b, and c,” should be understood as including only a, only b, only c, both a and b, both a and c, both b and c, all of a, b, and c, or any variations of the aforementioned examples.

While such terms as “first,” “second,” etc., may be used to describe various elements, such elements must not be limited to the above terms. The above terms may be used only to distinguish one element from another.

The term “component” is intended to be broadly construed as hardware, firmware, or a combination of hardware and software.

It will be apparent that systems and/or methods, described herein, may be implemented in different forms of hardware, firmware, or a combination of hardware and software. The actual specialized control hardware or software code used to implement these systems and/or methods is not limiting of the implementations. Thus, the operation and behavior of the systems and/or methods were described herein without reference to specific software code-it being understood that software and hardware may be designed to implement the systems and/or methods based on the description herein.

Even though particular combinations of features are recited in the claims and/or disclosed in the specification, these combinations are not intended to limit the disclosure of possible implementations. In fact, many of these features may be combined in ways not specifically recited in the claims and/or disclosed in the specification. Although each dependent claim listed below may directly depend on only one claim, the disclosure of possible implementations includes each dependent claim in combination with every other claim in the claim set.

No element, act, or instruction used herein should be construed as critical or essential unless explicitly described as such. Also, as used herein, the articles “a” and “an” are intended to include one or more items, and may be used interchangeably with “one or more.” Furthermore, as used herein, the term “set” is intended to include one or more items (e.g., related items, unrelated items, a combination of related and unrelated items, etc.), and may be used interchangeably with “one or more.” Where only one item is intended, the term “one” or similar language is used. Also, as used herein, the terms “has,” “have,” “having,” or the like are intended to be open-ended terms. Further, the phrase “based on” is intended to mean “based, at least in part, on” unless explicitly stated otherwise.

As discussed above, blind image restoration may refer to a process for restoring a degraded image without knowledge of the particular type of degradation that was applied to, or is exhibited by, the degraded image. Some approaches to blind image restoration involve image restoration models that are trained using supervised learning based on large synthetic training datasets. These synthetic training datasets may be generated by synthetically degrading target images using a handcrafted image degradation pipeline to generate synthetic degraded images. However, image restoration models trained on such synthetic degradations may be unable to properly restore input images (e.g., real degraded images) which exhibit types of image degradation that were not present in the synthetic degraded images on which they were trained. For example, when degraded images having unknown degradations are provided as input to these image restoration models, the output images which are generated may exhibit flaws or artifacts (e.g., severe artifacts on hair and over-smoothed skin).

Other approaches to blind image restoration may involve powerful generative models such as diffusion models. Despite not being initially designed for imaging tasks such as image restoration, some modified and specially-trained diffusion models may be used for tasks such as super-resolution (SR) processing, shadow removal, deblurring, inpainting, uncropping, face restoration, and adverse weather restoration. Various sampling and training procedures may be performed on diffusion models for better restoration performance. However, these diffusion models may require supervised training based on a large amount of training data pairs and computational resources, while still suffering from lack of adaptability to generalize to out-of-distribution degradations. In addition, pre-trained diffusion models may rely on knowledge of a degradation type of a degraded image to design custom denoising processes, which may not be applied to blind image restoration directly. Although these approaches may be capable of achieving high levels of perceptual quality, they may share the common problem of long inference time due to the need to run the diffusion model for every input.

Accordingly, embodiments may relate to a method of training an image restoration model in which a pre-trained image restoration model, which may be trained for example using a synthetic training dataset, may be fine-tuned based on pseudo-ground truth data generated at training time using a pre-trained diffusion model. According to embodiments, the pseudo-ground truth data may be images that may be referred to as pseudo-target images. Therefore, the performance of the pre-trained image restoration model may be improved without the burden of running the diffusion model at inference time.

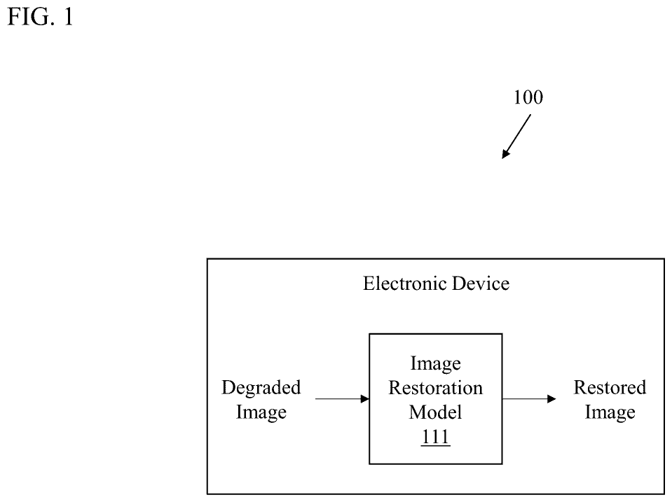

FIG. 1 is a diagram showing a general overview of an electronic device including an image restoration model, according to embodiments.

As shown in FIG. 1, an electronic device 100 may include an image restoration model 111, which may receive a degraded image, and may process the degraded image to obtain a restored image, for example by removing noise or other artifacts from the degraded image. In embodiments, the degraded image may be an image that is captured by a component of the electronic device 100, or may be received by the electronic device 100 from another device, for example using a wired or wireless network. According to embodiments, the image restoration model 111 may include one or more artificial intelligence (AI) models such as neural networks or machine learning models. For example, in some embodiments the image restoration model may be or may include a transformer model, but embodiments are not limited thereto.

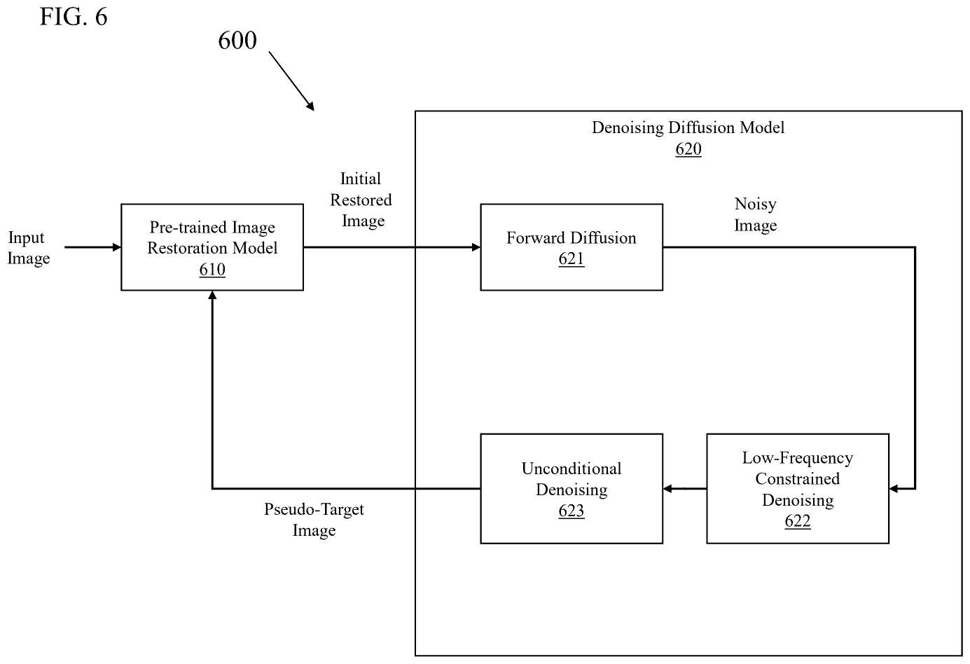

According to embodiments, the image restoration model 111 may be generated by performing additional training to fine-tune a pre-trained image restoration model (e.g., the pre-trained imaged restoration model 610 illustrated in FIG. 6) based on pseudo-target images generated from a set of degraded input images. In some embodiments, a denoising diffusion process may be used to generate the pseudo-target images by cleaning up output images generated by the pre-trained image restoration model, for example by preserving the input image content (e.g., low-frequency image data) while enhancing details (e.g., high-frequency image data). The cleaned images may be used as pseudo-target images to perform additional training in order to fine-tune the pre-trained image restoration model to obtain the image restoration model 111. After being fine-tuned by the additional training, the image restoration model 111 may be able to properly restore input images which exhibit different types of degradation. Although examples are described herein in which a pre-trained diffusion model (e.g., the denoising diffusion model 620 illustrated in FIG. 6) may be used to generate the pseudo-target images, embodiments are not limited thereto, and the pseudo-target images may be generated or other obtained in any manner, for example using any model architecture.

Accordingly, embodiments may perform unsupervised training using only a set of degraded input images, which may exhibit unknown degradations and without corresponding ground-truth target images, to fine-tune an image restoration model that may be used to generate clean and contextually-consistent outputs. Embodiments may use a pre-trained diffusion model as a generative prior through which high-quality images may be generated from the natural image distribution, while maintaining the input image content through consistency constraints. These generated images may be used as pseudo-target images to fine-tune the pre-trained restoration model. Unlike some approaches that employ a diffusion model or other computationally-expensive models at inference time, embodiments may use such models only to generate the pseudo-target images at training time, and thus may maintain an efficient inference-time performance. Accordingly, the image restoration model 111 may be trained using only a relatively small set of unpaired low-quality images, which may be much easier to obtain than a large paired training dataset.

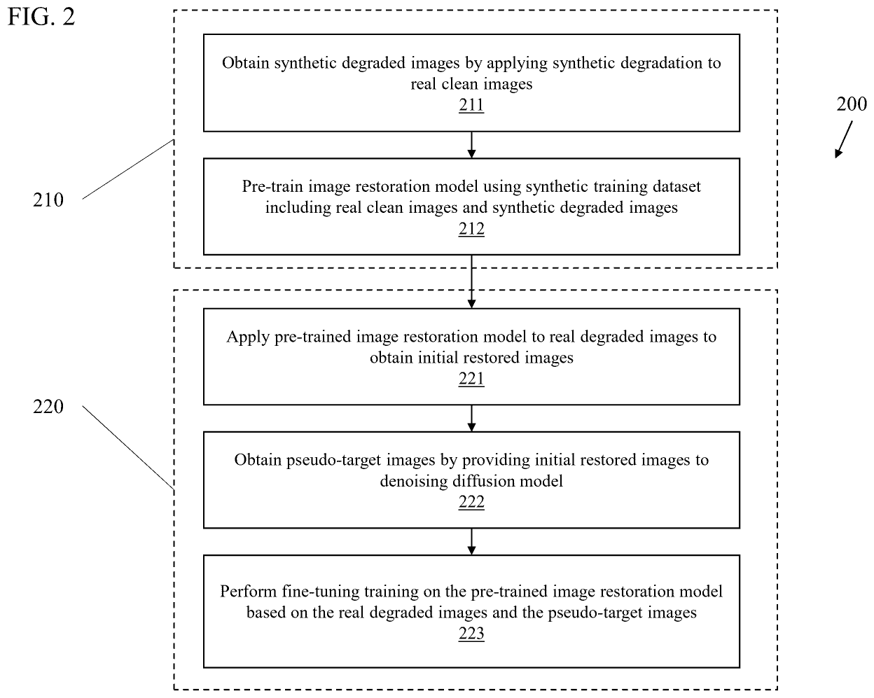

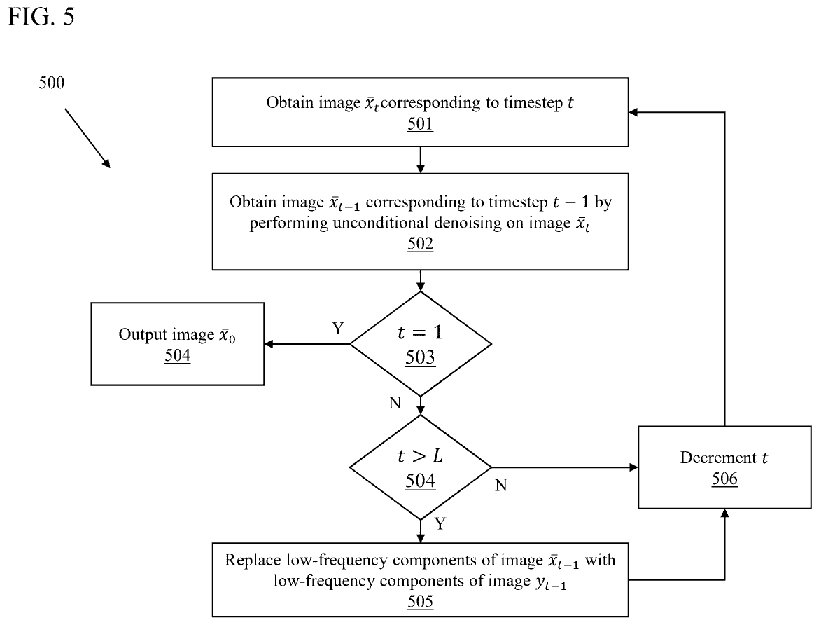

FIG. 2 is a flowchart of a process for training an image restoration model, according to embodiments. Given a pre-trained image restoration model that produces low-quality restored images based on input images with unknown and out-of-distribution degradations, the process 200 may include generating pseudo-target images using a pre-trained unconditional diffusion model with a combination of low-frequency content constrained denoising and unconditional denoising, examples of which are described in greater detail below with reference to FIGS. 5 and 6. The generated clean images may be used as pseudo-target images in order to fine-tune the pre-trained restoration model, reducing or eliminating the need for real ground-truth images.

According to embodiments, the process 200 may be a two-phase training process which may be used to train the image restoration model 111 discussed above. For example, the process 200 may include a pre-training phase 210, in which pre-training is performed to produce a pre-trained image restoration model is produced, and a fine-tuning phase 220, in which fine-tuning is performed on the pre-trained image restoration model to produce the image restoration model 111.

As shown in FIG. 2, the process 200 may begin at the pre-training phase 210, which may include operation 211 and operation 212.

At operation 211, the process 200 may include obtaining synthetic degraded images by applying synthetic degradation to real clean images. In embodiments, the synthetic degraded images and the real clean images may be referred to as a synthetic training dataset.

At operation 212, the process 200 may include pre-training the image restoration model using the synthetic training dataset. For example, the pre-training may include providing the synthetic degraded images to the image restoration model to obtain output images, calculating a loss based on the output images and the real clean images, and adjusting at least one parameter of the image restoration model to minimize the loss, but embodiments are not limited thereto. According to embodiments, the pre-trained image restoration model may be obtained as a result of the pre-training at operation 212.

Next, the process 200 may proceed to the fine-tuning phase 220, which may include operation 221, operation 222, and operation 223.

At operation 221, the process 200 may include providing real degraded images to the pre-trained image restoration model to obtain initial restored images.

At operation 222, the process 200 may include obtaining pseudo-target images by providing the initial restored images to a denoising diffusion model. In embodiments, the real degraded images and the pseudo-target images may be referred to as a fine-tuning training dataset.

At operation 223, the process 200 may include performing fine-tuning training on the pre-trained image restoration model using the fine-tuning training dataset. For example, the fine-tuning training may include providing the real degraded images to the pre-trained image restoration model to obtain output images, calculating a loss based on the output images and the pseudo-target images, and adjusting at least one parameter of the pre-trained image restoration model to minimize the loss, but embodiments are not limited thereto. According to embodiments, the image restoration model 111 may be obtained as a result of the pre-training at operation 212.

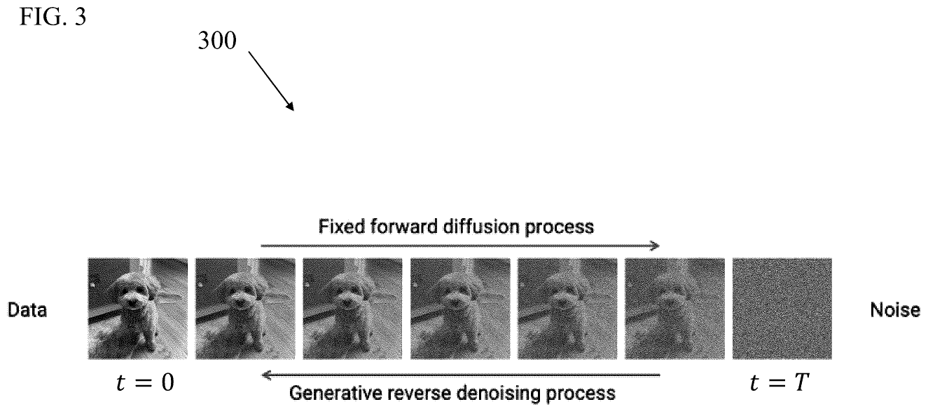

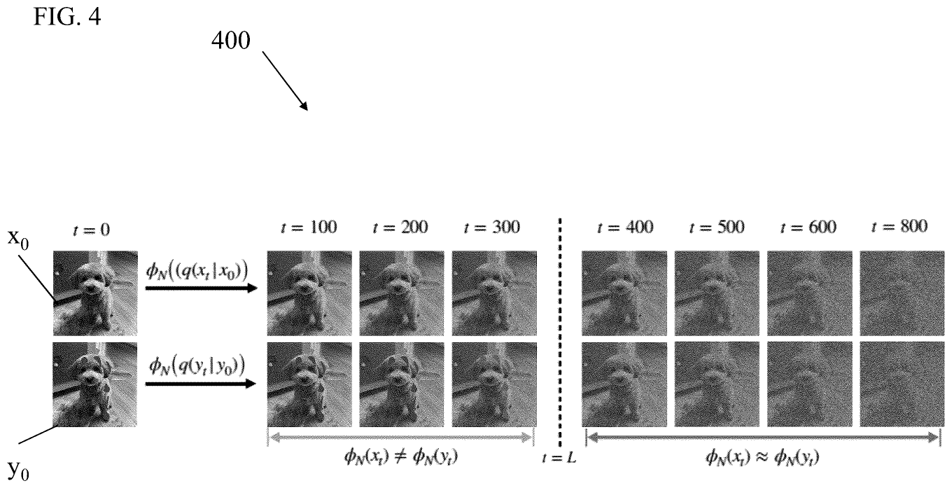

FIGS. 3 and 4 are diagrams illustrating examples of denoising diffusion processes, according to embodiments. In particular, FIG. 3 illustrates an example output 300 of a denoising diffusion model, and FIG. 4 illustrates an output of a low-frequency content constrained denoising diffusion process by showing a comparison 400 between outputs of the denoising diffusion model based on a clean image and a degraded image. The denoising diffusion model may be trained by gradually adding noise to an input image in a forward diffusion process, and estimating this noise and gradually denoising the image in a generative reverse denoising process, as shown in FIG. 3. In some embodiments, the denoising diffusion process illustrated in FIG. 3 may be performed by a denoising diffusion probabilistic model (DDPM), which may be a powerful generative model used in computer vision.

An unconditional diffusion model may learn a natural image manifold from large-scale image datasets. For example, the diffusion model may follow a Markov forward process to gradually corrupt a clean image x₀ with a predefined Gaussian noise variance schedule βₜ for each timestep t E {1, 2, . . . , T}. The noisy image xₜ at any timestep t, given the clean image x₀, may be obtained using Equation 1 below:

$$q ( {x}_{t} \vert {x}_{0} ) = 𝒩 ( {x}_{t} ; \sqrt{{\overline{α}}_{t}} {x}_{0} , ( 1 - {\overline{α}}_{t} ) I ) \qquad Equation 1$$

In Equation 1 above, αₜ=1−βₜ, and α̅ₜ=Πₛ₌₁^{t}αₛ.

An unconditional diffusion model may be used to generate natural images by reversing the forward diffusion process according to Equation 2 below:

$${p}_{θ} ( {x}_{t - 1} \vert {x}_{t} ) = 𝒩 ( {x}_{t - 1} ; {μ}_{θ} ( {x}_{t} , t ) , {σ}_{t}^{2} I ) \qquad Equation 2$$

In Equation 2 above, σₜ² may be set to a time-dependent constant, and the mean of the denoised image μ_{θ}(xₜ, t) may be expressed according to Equation 3 below:

$${μ}_{θ} ( {x}_{t} , t ) = \frac{1}{\sqrt{{α}_{t}}} ( {x}_{t} - \frac{( 1 - {α}_{t} )}{\sqrt{( 1 - {\overline{α}}_{t} )}} {ϵ}_{θ} ( {x}_{t} , t ) \qquad Equation 3$$

In Equation 3 above, ∈_{θ}(xₜ, t) may denote the noise at timestep t. In some embodiments, the noise ∈_{θ}(xₜ, t) may be predicted by a trained timestep conditioned U-Net. Unconditional image generation may begin with a sample from a standard Gaussian distribution x_{T}˜ [symbol] (0, I), which may be gradually denoised using the predicted noise at each timestep. In some embodiments, the denoising process may be accelerated using denoising diffusion implicit model (DDIM) techniques, or by simply uniformly skipping timesteps during the reverse diffusion process.

One potential problem with unconditional denoising diffusion is that hallucinations may be produced. Because the denoising process is a multi-step process in which the diffusion model may be applied many times (e.g., for each timestep), constraints may be applied at one or more intermediate timesteps to reduce or eliminate hallucination.

For example, consider a pre-trained restoration model R and a real degraded image y. Due to a domain gap between synthetic degraded images used to train the pre-trained restoration model [symbol] and the real degraded image y, the output image y₀= [symbol] (y) of the pre-trained restoration model may contain significant artifacts. Following Equation 1, the forward diffusion process may be applied to the image y₀, to obtain a noisy image yₜ at timestep t according to Equation 4 below:

$${y}_{t} = \sqrt{{\overline{α}}_{t}} {y}_{0} + \sqrt{1 - {\overline{α}}_{t}} ϵ , \qquad Equation 4$$

$$where$$

$$ϵ \sim 𝒩 ( 0 , I )$$

If an unconditional denoising is directly performed on the image yₜ, structural content (e.g., low-frequency content) included in the image yₜ may not be properly preserved, which may yield inconsistent restoration (e.g., hallucination). As more Gaussian noise is added (e.g., as the timestep t is increased), the low-frequency content of the image yₜ may become closer to the low-frequency content of the noisy image xₜ as if the forward diffusion process started with the clean image counterpart x₀. For example, given a low pass filter ϕ_{N}, if t is large enough (e.g., t>L), Equation 5 below may hold:

$${ϕ}_{N} ( {y}_{t} ) \approx {ϕ}_{N} ( {x}_{t} ) = {ϕ}_{N} ( \sqrt{{\overline{α}}_{t}} {x}_{0} + \sqrt{1 - {\overline{α}}_{t}} ϵ ) \qquad Equation 5$$

In Equation 5 above, xₜ may denote the noisy version of the clean image x₀, and e may denote the same sampled noise from Equation 4. Examples of the low-frequency contents of the images xₜ and yₜ are visualized and compared at different timesteps t in FIG. 4. In the example shown in FIG. 4, the images xₜ and yₜ may become closer as timestep t increases, and may be visually indistinguishable after t=400.

Therefore, according to embodiments, the denoising process may be constrained by regularizing the low-frequency content at each denoising timestep when t>L, in order to preserve the structural information. At lower timesteps (t<=L), the low-frequency property in Equation 5 may no longer hold, and applying such regularization may deteriorate the denoising process. In addition, because an unconditional diffusion model may be used, proceeding all the way to t=T may completely destroy all the information in the image. Therefore, the low-frequency constrained denoising process may be started at a smaller timestep t=K, where the low-frequency content may be not yet destroyed by the injected Gaussian noise.

Accordingly, the denoising process described above may be used to generate a pseudo-target image based on the output image (e.g., the image y₀) generated by the pre-trained image restoration model. For example, the image y₀ output from the pre-trained image restoration model may be injected with Gaussian noise following the pre-defined noise schedule to up to timestep t=K. As discussed above, the image y_{K} may be visually indistinguishable from a hypothetical image xx which may be generated by injecting noise into a proper clean image x₀. The noisy image y_{K} (≈x_{K}) may then be passed to the diffusion model to be cleaned up. In the following description, x̅_{K} may denote the image at step k in this denoising (reverse diffusion) process. The denoising process may be guided by constraining the low-frequency content to be consistent with the input image. This may be done by replacing the low-frequency content of the denoised image with the corresponding content from the noisy copy of the input image at each time step.

Some approaches apply such guidance on all denoising steps, which may lead to blurry outputs with artifacts due to over-constraining the denoised images on information that can be a mixture of signal and noise. However, according to embodiments, this low-frequency content constraint may be applied for timesteps when t>L. This is because the low-frequency property may not hold anymore for small timesteps (t≤L) as discussed above, and because the denoised images at these timesteps may already have reasonably good structure. Therefore, unconditional denoising may be performed for the remaining L timesteps, because unconditional denoising steps may contribute to high-frequency details at small timesteps. With this approach, there may be no need for directly estimating the pseudo-target image x₀ from the image x_{L} in one step and running another enhancement model on the generated image. An example process for generating a pseudo-target image is described below with reference to FIG. 5.

An example of a process for generating pseudo-target images is provided below with reference to FIG. 5.

FIG. 5 is a flowchart of a process for generating pseudo-target images, according to embodiments.

At operation 501, the process 500 may include obtaining an image xₜ corresponding to a timestep t. For example, in some embodiments, the process 500 may begin at the timestep t=K with an image x̅_{K}, which may be generated by injecting noise into the image y₀ up to the timestep K, but embodiments are not limited thereto.

At operation 502, the process 500 may include obtaining an image x̅ₜ₋₁ corresponding to a timestep t−1 by performing unconditional denoising on the image x̅ₜ. For example, the operation 502 may be performed by or using the diffusion models discussed above, but embodiments are not limited thereto.

At operation 503, the process 500 may include determining whether to terminate the process 500. For example, in some embodiments, operation 503 may include determining whether t=1, (e.g., determining whether x̅ₜ₋₁=x̅₀ is obtained at operation 502). Based on determining that t=1 (Y at operation 503), the process 500 may proceed to operation 504, in which the image x̅₀ (e.g., the pseudo-target image) may be output. Based on determining that t≠1 (N at operation 503), the process 500 may proceed to operation 504.

At operation 504, the process 500 may include determining whether to apply the low-frequency content constraint discussed above. For example, in some embodiments, operation 504 may include determining whether t>L. Based on determining that t>L (Y at operation 504), the process 500 may proceed to operation 504, in which low-frequency components of the image x̅ₜ̅₋̅₁̅ may be replaced with low-frequency components of the corresponding image yₜ₋₁, and then may proceed to operation 506. Based on determining that t≤L (N at operation 504), the process 500 may skip the low-frequency content constraint and proceed directly to operation 506.

At operation 506, the process 500 may include decrementing the timestep t and returning to operation 501. Accordingly, in some embodiments, the process 500 may begin with the image x̅_{K}, and may proceed backward through timesteps until the pseudo-target image x̅₀ is obtained.

FIG. 6 is a diagram for explaining a fine-tuning procedure for an image restoration model, according to embodiments. As shown in FIG. 6, the fine-tuning procedure 600 may be used to fine-tune a pre-trained image restoration model 610, which may be for example an image restoration model that is pre-trained using a synthetic training dataset which includes training pairs of high-quality training images and synthetically-degraded training images. A real degraded image (e.g., the image y discussed above) may be provided to the pre-trained image restoration model to obtain an initially-restored image (e.g., the image y₀ discussed above). The initially-restored image may contain artifacts due to the domain gap between the synthetic training dataset and the real degraded image. Accordingly, the initially-restored image may be provided to a denoising diffusion model 620, which may be used to perform forward diffusion 621 to obtain a noisy image (e.g., the image y_{K}≈x_{K} discussed above), and may also be used to perform low-frequency constrained denoising 622 and unconditional denoising 623 to obtain a pseudo-target image (e.g., the image x̅₀ discussed above). In embodiments, at least one of the low-frequency constrained denoising 622 and the unconditional denoising 623 may correspond to the process 500 discussed above. For example,

The initially-restored image and the pseudo-target image may then be used to fine-tune the pre-trained image restoration model 610 to obtain a fine-tuned image restoration model (e.g., the image restoration model 111 discussed above, which may also be referred to as a trained image restoration model). The fine-tuning training may be performed by computing a loss between the initially-restored image and the pseudo-target image, and then adjusting at least one parameter of the pre-trained image restoration model 610 based on the loss. For example, in some embodiments the fine-tuning training may be performed based on an image-level L1 loss [symbol] _{L1}, a perceptual loss such as learned perceptual image patch similarity (LPIPS) loss [symbol] _{LPIPS}, and an adversarial loss such as a generative adversarial network (GAN) loss [symbol] _{GAN}, as shown in Equation 6, Equation 7, and Equation 8 below:

$${ℒ}_{L 1} = {‖ ℛ ( y ) - {\overline{x}}_{0} ‖}_{1} \qquad Equation 6$$

$${ℒ}_{LPIPS} = LPIPS ( ℛ ( y ) , {\overline{x}}_{0} ) \qquad Equation 7$$

$${ℒ}_{GAN} = log ( 1 - 𝒟 ( ℛ ( y ) ) ) \qquad Equation 8$$

In Equations 6-8 above, [symbol] may denote the pre-trained image restoration model 610, and [symbol] may denote a discriminator model that outputs the probability of its input coming from the distribution of real images. This discriminator model may be optimized from scratch along with the restoration model, with a cross-entropy training objective according to Equation 9 below:

$${L}_{D} = {𝔼}_{x ∼ ℛ ( y )} [ ( - ( 1 - log 𝒟 ( x ) ) ] + {𝔼}_{x ∼ {ℙ}_{r}} [ - log 𝒟 ( x ) ] \qquad Equation 9$$

In Equation 9 above, [symbol] ᵣ may denote the distribution of real high-quality images. The complete training objective may be expressed according to Equation 10 below, in which λ_{LPIPS} and λ_{GAN} denote hyperparameters for the weights of the losses:

$$ℒ = {ℒ}_{L 1} + {λ}_{LPIPS} {ℒ}_{LPIPS} + {λ}_{GAN} {ℒ}_{GAN} \qquad Equation 10$$

According to embodiments, the fine-tuning training may allow the image restoration model 111 to mimic the output of the denoising diffusion model 620. In order to do so, the image restoration model 111 may be trained to add detail without causing structural changes to the restored image. This may be accomplished using the low-frequency constrained denoising 622 as discussed above.

In some embodiments, a plurality of real degraded images may be provided to the pre-trained image restoration model 610 to obtain corresponding plurality of pseudo-target images in order to create a fine-tuning training dataset, and then the fine-tuning training dataset may be used to perform the fine-tuning of the pre-trained image restoration model 610, but embodiments are not limited thereto.

In addition, in some embodiments, the fine-tuning training may be performed in multiple stages. For example, in some embodiments, the pre-trained image restoration model 610 may generate at least one initially-restored image, which may be used to generate at least one corresponding pseudo-target image, and then a first stage of fine-tuning training may be performed on the pre-trained image restoration model 610. Then, at least one new initially-restored image may be generated, which may be used to generate at least one new pseudo-target image, and then a second stage of fine-tuning training may be performed on the pre-trained image restoration model 610. The fine-tuning training may then continue for as many stages as desired.

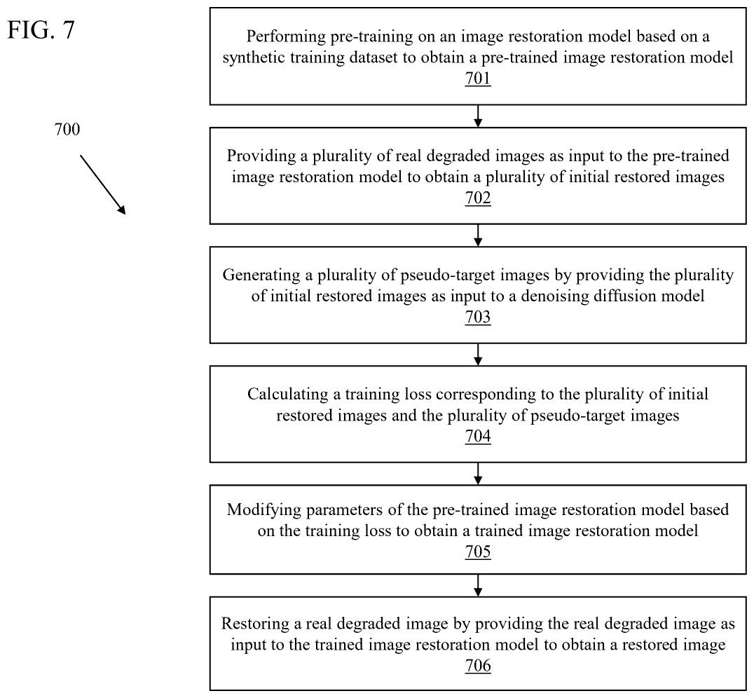

FIG. 7 is a flowchart of a process for training an image restoration model, according to embodiments.

At operation 701, the process 700 may include performing pre-training on an image restoration model based on a synthetic training dataset to obtain a pre-trained image restoration model. In embodiments, the pre-trained image restoration model may correspond to the pre-trained image restoration model 610 discussed above.

At operation 702, the process 700 may further include providing a plurality of real degraded images as input to the pre-trained image restoration model to obtain a plurality of initial restored images.

At operation 703, the process 700 may further include generating a plurality of pseudo-target images by providing the plurality of initial restored images as input to a denoising diffusion model. In embodiments, the denoising diffusion model may correspond to the denoising diffusion model 620 discussed above.

At operation 704, the process 700 may further include calculating a training loss corresponding to the plurality of initial restored images and the plurality of pseudo-target images.

At operation 705, the process 700 may further include modifying parameters of the pre-trained image restoration model based on the training loss to obtain a trained image restoration model. In embodiments, the trained image restoration model may correspond to the image restoration model 111 discussed above. In embodiments, the modifying of the parameters of the pre-trained image restoration model may correspond to the fine-tuning training discussed above.

At operation 706, the process 700 may further include restoring a real degraded image by providing the real degraded image as input to the trained image restoration model to obtain a restored image.

In some embodiments, operation 701 may correspond to the pre-training phase 210 discussed above, and operations 702 through 705 may correspond to the fine-tuning phase 220 discussed above, but embodiments are not limited thereto.

In embodiments, the synthetic training dataset may be obtained by obtaining a plurality of real images, and applying synthetic degradation to the plurality of real images to obtain a plurality of synthetic degraded images. * In embodiments, the generating of the plurality of pseudo-target images may include applying a forward diffusion process and a reverse denoising process to the plurality of initial restored images.

In embodiments, the forward diffusion process may include a plurality of forward diffusion steps, and the reverse denoising process comprises a plurality of reverse diffusion steps.

In embodiments, the reverse denoising process may include applying a constraint on a predetermined number of steps from among the plurality of reverse diffusion steps.

In embodiments, the applying the constraint may include performing denoising on a high-frequency component of an intermediate image corresponding to a reverse diffusion step from among the plurality of reverse diffusion steps, without performing the denoising on a low-frequency component of the intermediate image.

In embodiments, remaining steps from among the plurality of reverse diffusion steps may be unconstrained.

Accordingly, embodiments may provide a framework for unsupervised training of an image restoration model. The framework may include pre-training a restoration model on synthetic data, applying the pre-trained model to out-of-distribution data (e.g., real degraded data) to obtain initially-restored data, correcting artifacts in the initially-restored data using a diffusion model to obtain pseudo ground-truth data, and then fine-tuning the image restoration model using the pseudo-ground truth data. Accordingly, the fine-tuned image restoration model may be used to perform high-quality image restoration without the complexity or cost of operating the diffusion model at inference time.

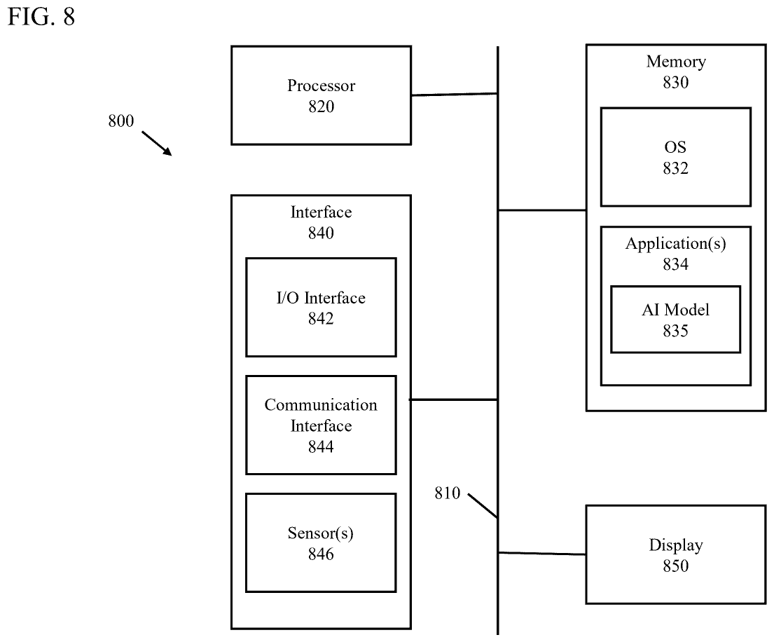

FIG. 8 is a block diagram of an electronic device according to embodiments

FIG. 8 is for illustration only, and other embodiments of the electronic device 800 could be used without departing from the scope of this disclosure. For example, the electronic device 800 may correspond to the electronic device 110.

The electronic device 800 includes a bus 810, a processor 820, a memory 830, an interface 840, and a display 850.

The bus 810 includes a circuit for connecting the components 820 to 850 with one another. The bus 810 functions as a communication system for transferring data between the components 820 to 850 or between electronic devices.

The processor 820 includes one or more of a central processing unit (CPU), a graphics processor unit (GPU), an accelerated processing unit (APU), a many integrated core (MIC), a field-programmable gate array (FPGA), or a digital signal processor (DSP). The processor 820 is able to perform control of any one or any combination of the other components of the electronic device 800, and/or perform an operation or data processing relating to communication. For example, the processor 820 may perform operations of the process 200 illustrated in FIG. 2, the process 500 illustrated in FIG. 5, and the process 700 illustrated in FIG. 7. The processor 820 executes one or more programs stored in the memory 830.

The memory 830 may include a volatile and/or non-volatile memory. The memory 830 stores information, such as one or more of commands, data, programs (one or more instructions), applications 834, etc., which are related to at least one other component of the electronic device 800 and for driving and controlling the electronic device 800. For example, commands and/or data may formulate an operating system (OS) 832. Information stored in the memory 830 may be executed by the processor 820.

The applications 834 include the above-discussed embodiments. These functions can be performed by a single application or by multiple applications that each carry out one or more of these functions. For example, the applications 834 may include one or more AI models for performing operations of the process 200 illustrated in FIG. 2, the process 500 illustrated in FIG. 5, and the process 700 illustrated in FIG. 7. Specifically, the applications 834 may include at least one of a pre-trained image restoration model, a denoising diffusion model, and a fine-tuned image restoration model or trained image restoration model, according to embodiments of the disclosure.

The display 850 includes, for example, a liquid crystal display (LCD), a light emitting diode (LED) display, an organic light emitting diode (OLED) display, a quantum-dot light emitting diode (QLED) display, a microelectromechanical systems (MEMS) display, or an electronic paper display.

The interface 840 includes input/output (I/O) interface 842, communication interface 844, and/or one or more sensors 846. The I/O interface 842 serves as an interface that can, for example, transfer commands and/or data between a user and/or other external devices and other component(s) of the electronic device 800.

The communication interface 844 may include a transceiver to enable communication between the electronic device 800 and other external devices (e.g., a sensor node or a fusion center), via a wired connection, a wireless connection, or a combination of wired and wireless connections. The communication interface 844 may permit the electronic device 800 to receive information from another device and/or provide information to another device. For example, the communication interface 844 may include an Ethernet interface, an optical interface, a coaxial interface, an infrared interface, a radio frequency (RF) interface, a universal serial bus (USB) interface, a Wi-Fi interface, a cellular network interface, or the like.

The transceiver of the communication interface 844 may include a radio frequency (RF) circuitry and a baseband circuitry.

The baseband circuitry may transmit and receive a signal through a wireless channel, and may perform band conversion and amplification on the signal. The RF circuitry may up-convert a baseband signal provided from the baseband circuitry into an RF band signal and then transmits the converted signal through an antenna, and down-converts an RF band signal received through the antenna into a baseband signal. For example, the RF circuitry may include a transmission filter, a reception filter, an amplifier, a mixer, an oscillator, a digital-to-analog converter (DAC), and an analog-to-digital converter (ADC).

The transceiver may be connected to one or more antennas. The RF circuitry of the transceiver may include a plurality of RF chains and may perform beamforming. For the beamforming, the RF circuitry may control a phase and a size of each of the signals transmitted and received through a plurality of antennas or antenna elements. The RF circuitry may perform a downlink multi-input and multi-output (MIMO) operation by transmitting one or more layers.

The baseband circuitry may perform conversion between a baseband signal and a bitstream according to a physical layer standard of the radio access technology. For example, when data is transmitted, the baseband circuitry generates complex symbols by encoding and modulating a transmission bitstream. When data is received, the baseband circuitry reconstructs a reception bitstream by demodulating and decoding a baseband signal provided from the RF circuitry.

The sensor(s) 846 of the interface 840 can meter a physical quantity or detect an activation state of the electronic device 800 and convert metered or detected information into an electrical signal. For example, the sensor(s) 846 can include one or more cameras or other imaging sensors for capturing images of scenes. The sensor(s) 846 can also include any one or any combination of a microphone, a keyboard, a mouse, and one or more buttons for touch input. The sensor(s) 846 can further include an inertial measurement unit. In addition, the sensor(s) 846 can include a control circuit for controlling at least one of the sensors included herein. Any of these sensor(s) 846 can be located within or coupled to the electronic device 800.

The foregoing disclosure provides illustration and description, but is not intended to be exhaustive or to limit the implementation to the precise form disclosed. Modifications and variations are possible in light of the above disclosure or may be acquired from practice of the implementation.

As used herein, the term “component” is intended to be broadly construed as hardware, firmware, or a combination of hardware and software.

It will be apparent that systems and/or methods, described herein, may be implemented in different forms of hardware, firmware, or a combination of hardware and software. The actual specialized control hardware or software code used to implement these systems and/or methods is not limiting of the implementations. Thus, the operation and behavior of the systems and/or methods were described herein without reference to specific software code-it being understood that software and hardware may be designed to implement the systems and/or methods based on the description herein.

Even though particular combinations of features are recited in the claims and/or disclosed in the specification, these combinations are not intended to limit the disclosure of possible implementations. In fact, many of these features may be combined in ways not specifically recited in the claims and/or disclosed in the specification. Although each dependent claim listed below may directly depend on only one claim, the disclosure of possible implementations includes each dependent claim in combination with every other claim in the claim set.

The embodiments of the disclosure described above may be written as computer executable programs or instructions that may be stored in a medium.

The medium may continuously store the computer-executable programs or instructions, or temporarily store the computer-executable programs or instructions for execution or downloading. Also, the medium may be any one of various recording media or storage media in which a single piece or plurality of pieces of hardware are combined, and the medium is not limited to a medium directly connected to electronic device 800, but may be distributed on a network. Examples of the medium include magnetic media, such as a hard disk, a floppy disk, and a magnetic tape, optical recording media, such as CD-ROM and DVD, magneto-optical media such as a floptical disk, and ROM, RAM, and a flash memory, which are configured to store program instructions. Other examples of the medium include recording media and storage media managed by application stores distributing applications or by websites, servers, and the like supplying or distributing other various types of software.

The methods and processes described above may be provided in a form of downloadable software. A computer program product may include a product (for example, a downloadable application) in a form of a software program electronically distributed through a manufacturer or an electronic market. For electronic distribution, at least a part of the software program may be stored in a storage medium or may be temporarily generated. In this case, the storage medium may be a server or a storage medium of the electronic device 800.

A model related to the neural networks described above may be implemented via a software module. When the model is implemented via a software module (for example, a program module including instructions), the model may be stored in a computer-readable recording medium.

Also, the model may be a part of the electronic device 800 described above by being integrated in a form of a hardware chip. For example, the model may be manufactured in a form of a dedicated hardware chip for artificial intelligence, or may be manufactured as a part of an existing general-purpose processor (for example, a CPU or application processor) or a graphic-dedicated processor (for example a GPU).

Also, the model may be provided in a form of downloadable software. A computer program product may include a product (for example, a downloadable application) in a form of a software program electronically distributed through a manufacturer or an electronic market. For electronic distribution, at least a part of the software program may be stored in a storage medium or may be temporarily generated. In this case, the storage medium may be a server of the manufacturer or electronic market, or a storage medium of a relay server.

While the embodiments of the disclosure have been described with reference to the figures, it will be understood by those of ordinary skill in the art that various changes in form and details may be made therein without departing from the spirit and scope as defined by the following claims.

What is claimed is:

1. A method of training an image restoration model, the method comprising:
performing pre-training on the image restoration model based on a synthetic training dataset to obtain a pre-trained image restoration model;
providing a plurality of real degraded images as input to the pre-trained image restoration model to obtain a plurality of initial restored images;
generating a plurality of pseudo-target images by providing the plurality of initial restored images as input to a denoising diffusion model;
calculating a training loss corresponding to the plurality of initial restored images and the plurality of pseudo-target images; and
modifying at least one parameter of the pre-trained image restoration model based on the training loss to obtain a trained image restoration model.

2. The method of claim 1, further comprising:
restoring a real degraded image by providing the real degraded image as input to the trained image restoration model to obtain a restored image.

3. The method of claim 1, wherein the synthetic training dataset is obtained by obtaining a plurality of real images, and applying synthetic degradation to the plurality of real images to obtain a plurality of synthetic degraded images.

4. The method of claim 1, wherein the generating of the plurality of pseudo-target images comprises applying a forward diffusion process and a reverse denoising process to the plurality of initial restored images.

5. The method of claim 4, wherein the forward diffusion process comprises a plurality of forward diffusion steps, and
wherein the reverse denoising process comprises a plurality of reverse diffusion steps.

6. The method of claim 5, wherein the reverse denoising process comprises applying a constraint on a predetermined number of steps from among the plurality of reverse diffusion steps.

7. The method of claim 6, wherein the applying the constraint comprises performing denoising on a high-frequency component of an intermediate image corresponding to a reverse diffusion step from among the plurality of reverse diffusion steps, without performing the denoising on a low-frequency component of the intermediate image.

8. The method of claim 6, wherein remaining steps from among the plurality of reverse diffusion steps are unconstrained.

9. An electronic device for training an image restoration model, the electronic device comprising:
at least one memory configured to store instructions; and
at least one processor configured to execute the instructions to:
perform pre-training on the image restoration model based on a synthetic training dataset to obtain a pre-trained image restoration model;
provide a plurality of real degraded images as input to the pre-trained image restoration model to obtain a plurality of initial restored images;
generate a plurality of pseudo-target images by providing the plurality of initial restored images as input to a denoising diffusion model;
calculate a training loss corresponding to the plurality of initial restored images and the plurality of pseudo-target images; and
modify at least one parameter of the pre-trained image restoration model based on the training loss to obtain a trained image restoration model.

10. The electronic device of claim 9, wherein the at least one processor is further configured to:
restore a real degraded image by providing the real degraded image as input to the trained image restoration model to obtain a restored image.

11. The electronic device of claim 9, wherein the synthetic training dataset is obtained by obtaining a plurality of real images, and applying synthetic degradation to the plurality of real images to obtain a plurality of synthetic degraded images.

12. The electronic device of claim 9, wherein to generate the plurality of pseudo-target images, the at least one processor is further configured to apply a forward diffusion process and a reverse denoising process to the plurality of initial restored images.

13. The electronic device of claim 12, wherein the forward diffusion process comprises a plurality of forward diffusion steps, and
wherein the reverse denoising process comprises a plurality of reverse diffusion steps.

14. The electronic device of claim 13, wherein the reverse denoising process comprises applying a constraint on a predetermined number of steps from among the plurality of reverse diffusion steps.

15. The electronic device of claim 14, wherein to apply the constraint, the at least one processor is further configured to perform denoising on a high-frequency component of an intermediate image corresponding to a reverse diffusion step from among the plurality of reverse diffusion steps, without performing the denoising on a low-frequency component of the intermediate image.

16. The electronic device of claim 14, wherein remaining steps from among the plurality of reverse diffusion steps are unconstrained.

17. A non-transitory computer-readable medium storing instructions which, when executed by at least one processor of a device for training an image restoration model, cause the device to:
perform pre-training on the image restoration model based on a synthetic training dataset to obtain a pre-trained image restoration model;
provide a plurality of real degraded images as input to the pre-trained image restoration model to obtain a plurality of initial restored images;
generate a plurality of pseudo-target images by providing the plurality of initial restored images as input to a denoising diffusion model;
calculate a training loss corresponding to the plurality of initial restored images and the plurality of pseudo-target images; and
modify at least one parameter of the pre-trained image restoration model based on the training loss to obtain a trained image restoration model.

18. The non-transitory computer-readable medium of claim 17, wherein the instructions further cause the at least one processor to:
restore a real degraded image by providing the real degraded image as input to the trained image restoration model to obtain a restored image.

19. The non-transitory computer-readable medium of claim 17, wherein the synthetic training dataset is obtained by obtaining a plurality of real images, and applying synthetic degradation to the plurality of real images to obtain a plurality of synthetic degraded images.

20. The non-transitory computer-readable medium of claim 17, wherein to generate the plurality of pseudo-target images, the instructions further cause the at least one processor to apply a forward diffusion process and a reverse denoising process to the plurality of initial restored images.
